(19) United States
(12) Patent Application Publication
(10) Pub. No.: US 2026/0252658 A1
(43) Pub. Date: Aug. 27, 2026

(54) WEBSITE PERFORMANCE OPTIMIZATION METHOD AND RELATED PRODUCTS THEREOF

(71) Applicants: Nanjing Xiyin Ecommerce Co., Ltd., Jiangsu (CN); Guangzhou Xiyin International Import and Export Co., Ltd., Guangdong (CN); Shenzhen Xiyin Information Technology Co., Ltd., Guangdong (CN)

(72) Inventors: YANG CHENG, Jiangsu (CN); XIONGJIE YANG, Jiangsu (CN); TAO JIANG, Jiangsu (CN); FENG LIN, Jiangsu (CN); HUI LIU, Jiangsu (CN); HONGLONG LI, Jiangsu (CN); XIAOJUN YAN, Jiangsu (CN); SHISHUO CHEN, Jiangsu (CN)

(21) Appl. No.: 19/311,225

(22) Filed: Aug. 27, 2025

(30) Foreign Application Priority Data
Feb. 25, 2025 (CN) 2025102142363

(51) Int. Cl. G06F 16/957; H04L 67/61

(52) U.S. Cl. CPC G06F 16/9577; H04L 67/61

(57) ABSTRACT

A website performance optimization method includes creating performance baseline data, performing performance optimization for each website core scenario related to performance data, and outputting a performance test report and runtime information data, determining a performance change condition of the website based on the performance baseline data, the performance test report and the runtime information data, and determining whether to end a performance optimization cycle based on the performance change condition.

### CROSS-REFERENCE TO RELATED APPLICATION AND CLAIM OF PRIORITY

This application claims the benefit under 35 USC § 119 of Chinese Patent Application No. 2025102142363, filed on Feb. 25, 2025, in the China Intellectual Property Office, the entire disclosure of which is incorporated herein by reference for all purposes.

### BACKGROUND

### 1. TECHNICAL FIELD

The present application generally relates to the field of internet technology. More particularly, the present application relates to a website performance optimization method and related products thereof.

### 2. BACKGROUND ART

On the road of pursuing high business growth, optimizing user experience is obviously crucial for driving positive conversion. Among various factors, the duration of application launching time will directly affect user retention rates. With the continuous increase of launching programs, thread blocking may occur in the launching process due to unreasonable scheduling of the launching framework. Meanwhile, the GSON parser, on which the homepage data processing relies, generates lots of reflection during parsing, thereby slowing down the data processing. In addition, due to the rich content of the homepage, the success rate of layout preloading optimization is relatively low. For example, in some merchandise display scenarios, many merchandise labels need to be displayed, which not only causes a bloated layout, but also seriously affects the efficiency of layout measurement.

In view of this, there is an urgent need for a website performance optimization method which can implement performance optimization of the website, improve the overall user experience, and therefore increase the user retention rate and the e-commerce conversion rate.

### SUMMARY

To address at least one or more of the above technical problems, the present application proposes, in various aspects, a website performance optimization method and related products thereof. The website performance optimization method can implement performance optimization of the website, improve the overall user experience, and therefore increase the user retention rate and the e-commerce conversion rate.

In a first aspect, the present application provides a website performance optimization method, including: creating performance baseline data; performing performance optimization for each website core scenario related to performance data, and outputting a performance test report and runtime information data; determining a performance change condition of the website based on the performance baseline data, the performance test report and the runtime information data; and determining whether to end a performance optimization cycle based on the performance change condition.

In some embodiments, creating the performance baseline data includes: acquiring a processor frequency and memory information of each user device and first screen paint information of each user device loading the website; determining a model rating of each user device based on its processor frequency and the memory information; and determining the performance baseline data based on the first screen paint information of each user device loading the website and the model rating of each user device.

In some embodiments, the website core scenario is a first screen launching scenario, wherein performance optimization of the first screen launching scenario includes: optimizing a launching task, a first screen link task and thread convergence; preloading first screen resources; and configuring a corresponding data parsing tool based on a data volume size.

In some embodiments, the website core scenario is a long list scenario, wherein performance optimization of the long list scenario includes: performing data splitting and optimization based on a first screen display content and service data query time; preloading layout resources; and optimizing layout rendering.

In some embodiments, the website core scenario is a home tab scenario, wherein performance optimization of the home tab scenario includes: preloading tab resources.

In some embodiments, the website core scenario is a network dependent scenario, wherein performance optimization of the network dependent scenario includes: giving priority to processing of a status request operation and callback feedback of a request result subscription message.

In some embodiments, determining the performance change condition of the website based on the performance baseline data, the performance test report and the runtime information data includes: determining a performance target difference based on performance test data in the performance test report and the performance baseline data; determining whether an additional performance issue is generated based on the performance test report and a previous version of a current performance test report; determining a website performance growth stage based on index settlement information in the runtime information data; and determining, based on program execution logs and runtime event traces in the runtime information data, whether a problem exists in a program runtime environment, a network request condition or a service logic.

In some embodiments, determining whether to end the performance optimization cycle based on the performance change condition includes: if the performance change condition is performance optimization, determining to end the performance optimization cycle; and if the performance change condition is performance deterioration, repeating the step of performing performance optimization for each website core scenario related to performance data, and outputting a performance test report and runtime information data.

In a second aspect, the present application provides a website performance optimization device, including: a memory; and at least one processor configured to: create performance baseline data; perform performance optimization for each website core scenario related to performance data, and output a performance test report and runtime information data; determine a performance change condition of the website based on the performance baseline data, the performance test report and the runtime information data; and determine whether to end a performance optimization cycle based on the performance change condition.

In a third aspect, the present application provides a non-transitory machine-readable medium having a program code for website performance optimization stored thereon which, when executed by at least one processor, directs the at least one processor to perform the operations of: creating performance baseline data; performing performance optimization for each website core scenario related to performance data, and outputting a performance test report and runtime information data; determining a performance change condition of the website based on the performance baseline data, the performance test report and the runtime information data; and determining whether to end a performance optimization cycle based on the performance change condition.

The technical solutions of the present application may achieve the following beneficial effects:

According to the website performance optimization method and the related products thereof provided in the present application, by creating performance baseline data, performing performance optimization for each website core scenario related to performance data, and outputting a performance test report and runtime information data, and further determining a performance change condition of the website based on the performance baseline data, the performance test report and the runtime information data, the website performance condition can be monitored to identify and prevent potential performance degradation problems; and by further determining whether to end a performance optimization cycle based on the performance change condition, it is ensured that each performance optimization iteration will not influence the user experience negatively so that the satisfaction and retention rate of users are improved.

In general, the present application can implement performance optimization of the website, improve the overall user experience, and therefore increase the user retention rate and the e-commerce conversion rate.

### BRIEF DESCRIPTION OF THE DRAWINGS

The above and other objectives, features and advantages of exemplary implementations of the present application will become readily apparent from the following detailed description, which proceeds with reference to the accompanying drawings. In the accompanying drawings, several implementations of the present application are illustrated by way of example but not limitation, and like or corresponding reference numerals indicate like or corresponding parts, in which:

FIG. 1 shows an exemplary flowchart of a website performance optimization method according to some embodiments of the present application;

FIG. 2 shows an exemplary flowchart of a website performance optimization method according to some other embodiments of the present application;

FIG. 3 shows an exemplary flowchart of a website performance optimization method according to yet other embodiments of the present application;

FIG. 4 shows a block diagram of a hardware configuration of a website performance optimization device 400 that can implement the website performance optimization method according to an embodiment of the present application.

### DETAILED DESCRIPTION

The technical solutions in the embodiments of the present application will be clearly and completely described below with reference to the accompanying drawings in the embodiments of the present application. Apparently, the described embodiments are only part, but not all, of the embodiments of the present application. For simplicity and clarity of illustration, where considered appropriate, reference numerals may be repeated among the figures to indicate corresponding or analogous elements. In addition, the present application sets forth numerous specific details to provide a thorough understanding of the embodiments described herein. However, it will be understood by one of ordinary skill in the art that the embodiments described herein may be practiced without these specific details. In other instances, well-known methods, procedures, and components have not been described in detail so as not to obscure the embodiments described herein. Moreover, the description should not be taken as limitations to the scope of the embodiments described herein. All other embodiments obtained by those skilled in the art based on the embodiments in the present application without any creative labor belong to the protection scope of the present application.

It should be understood that the possible terms “first” or “second” or the like in the claims, description and drawings disclosed in the present application are used to distinguish different objects, and are not used to describe a particular order. The terms “comprise” and “include”, when used in the description and claims of the present application, specify the presence of the stated features, integers, steps, operations, elements, and/or components, but do not preclude the presence or addition of one or more other features, integers, steps, operations, elements, components, and/or groups thereof.

It is also to be understood that the terminology used in the description of the present application herein is for the purpose of describing particular embodiments only, and is not intended to limit the present application. As used in the specification and claims of the present application, the singular forms “a”, “an” and “the” are intended to include the plural forms as well, unless the context clearly indicates otherwise. It should be further understood that the term “and/or” as used in the description and claims of the present application refers to any and all possible combinations of one or more of the associated listed items and includes such combinations.

As used in this specification and claims, the term “if” may be interpreted as “when” or “once” or “in response to determining” or “in response to detecting” depending on the context. Similarly, the phrase “if it is determined” or “if [the described condition or event] is detected” may be interpreted contextually as meaning “upon determining” or “in response to determining” or “upon detecting [the described condition or event]” or “in response to detecting [the described condition or event]”.

The application launching time will directly affect the retention rate of users. With the increase of launching programs, thread blocking may occur in the launching process due to unreasonable scheduling of the launching framework. Meanwhile, the GSON parser, on which the homepage data processing relies, generates lots of reflection during parsing, thereby slowing down the data processing. In addition, due to the rich content of the home page, the success rate of layout preloading optimization is relatively low. For example, in some merchandise display scenarios, many merchandise labels need to be displayed, which not only causes a bloated layout, but also seriously affects the efficiency of layout measurement.

In view of this, the present application provides a website performance optimization method which can implement performance optimization of the website, improve the overall user experience, and therefore increase the user retention rate and the e-commerce conversion rate.

Specific implementations of the present application will be described in detail below with reference to the accompanying drawings.

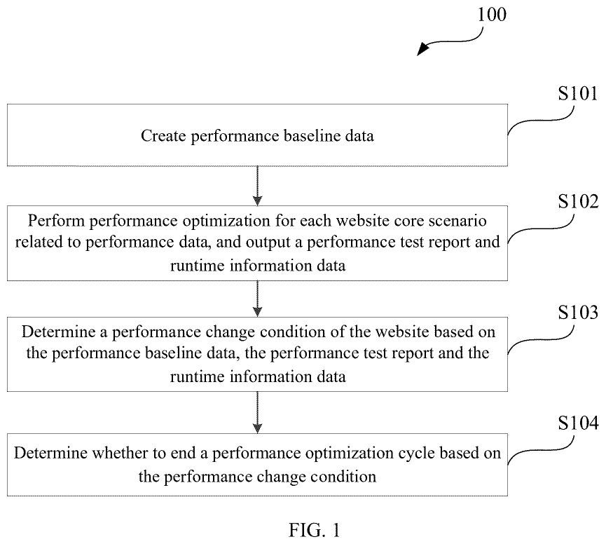

FIG. 1 shows an exemplary flowchart of a website performance optimization method according to some embodiments of the present application.

In step S101, performance baseline data is created. In an embodiment of the present application, the performance baseline data refers to reference standard data provided for website performance optimization. For example, the performance baseline data may be first screen paint (FSP) data, where FSP is the time required from a user clicking on a website portal link to the website page content completely presented, i.e., the time from the start of loading the website page to complete painting of the first screen content, which may be used to measure the website performance. It will be appreciated that while the user is waiting for the page to be loaded, rapid presentation of the first screen content can significantly increase the user satisfaction, and if the first screen takes too long time to be loaded, the user may feel impatient and even leave the page.

In the embodiments of the present application, the performance baseline data may be represented by a top percentile (TP) index of the first screen paint, where the TP index of the first screen paint refers to statistics of time consumed each time a first screen of a website page is loaded within a time period, where times are sorted in a sequence from small to large, and a time value corresponding to a value with a sequence number obtained by multiplying a statistical counts by an index parameter (for example, the index parameter of TP50 is 50%) is taken out and used as a critical value for evaluating a first screen paint level. For example, TP50<500 ms may indicate instant website launching, TP50<1000 ms may indicate sub-second website launching, and TP50<1200 ms may indicate near sub-second website launching, and TP50<500 ms, TP50<1000 ms and TP50<1200 ms constitute the performance baseline data.

In step S102, performance optimization is performed for each website core scenario related to performance data, and a performance test report and runtime information data are output. In an embodiment of the present application, the website core scenario related to performance data may be any one of a first screen launching scenario, a long list scenario, a home tab scenario, a network dependent scenario, or the like, each of which is matched with a corresponding performance optimization policy. When all the website core scenarios are optimized, test operation may be performed through a laboratory machine room to output a performance test report and runtime information data. The performance test report includes website performance data (such as first screen paint, frame rate, resource occupation, and the like) and screen recording sensory data (which refers to subjective quality indexes related to user experience, such as stutter detection data, structural similarity, perceptual weighted mean square error, and the like) obtained through a laboratory machine room test. In addition, the runtime information data may include, but is not limited to, information data generated during operation of the website, such as program execution logs (i.e., logs), runtime event traces (i.e., traces), and index settlement information (including data of time consumed by each stage of the first screen link).

In step S103, a performance change condition of the website is determined based on the performance baseline data, the performance test report and the runtime information data. It will be appreciated that new performance issues may be introduced during the website performance optimization process and instead lead to the deterioration of the website performance, and therefore, performance changes of the website should be analyzed based on the performance baseline data, the performance test report, and the runtime information data to effectively prevent deterioration of the website performance.

In step S104, it is determined whether to end a performance optimization cycle based on the performance change condition. In the embodiments of the present application, the performance change condition may include performance optimization and performance deterioration. If the performance change condition is performance optimization, the current performance optimization cycle may be ended, an iteratively updated website may be issued, and a performance test report and runtime information data generated after this performance optimization may be stored for performance change analysis in a next performance optimization cycle.

In the embodiments of the present application, by creating performance baseline data, performing performance optimization for each website core scenario related to performance data, and outputting a performance test report and runtime information data, and further determining a performance change condition of the website based on the performance baseline data, the performance test report and the runtime information data, the website performance condition can be monitored to identify and prevent potential performance degradation problems; and by further determining whether to end a performance optimization cycle based on the performance change condition, it is ensured that each performance optimization iteration will not influence the user experience negatively so that the satisfaction and retention rate of users are improved. In general, the present application can implement performance optimization of the website, improve the overall user experience, and therefore increase the user retention rate and the e-commerce conversion rate.

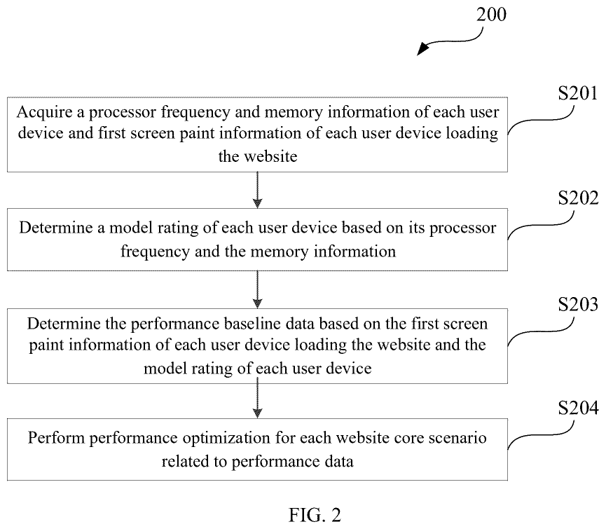

In some embodiments, the performance baseline data corresponding to each user device may be evaluated by collecting device information of the user, and a performance optimization policy corresponding to each website core scenario can be further designed. The determination of the performance baseline data and the performance optimization process for each website core scenario are described in detail below in conjunction with FIG. 2. FIG. 2 shows an exemplary flowchart of a website performance optimization method according to some other embodiments of the present application. Referring to FIG. 2, a website performance optimization method according to an embodiment of the present application may include the following steps S201 to S204.

In step S201, a processor frequency and memory information of each user device and first screen paint information of each user device loading the website are acquired. In an embodiment of the present application, the processor frequency and the memory information of the user device may be acquired by reporting the processor frequency and the memory information of the user device by a user. The first screen paint information of each user device loading the website may be monitored when each user device launches the website via an app or a web. It will be appreciated that the processor frequency and the memory information of each user device and the first screen paint information of each user device loading the website may be acquired in various manners, and in practical applications, a suitable acquiring manner may be selected according to the practical application conditions, which is not limited in any way in the present application.

In step S202, based on the processor frequency and the memory information of each user device, a model rating of each user device is determined. In an embodiment of the present application, a weighted score may be assigned to each user device based on the processor frequency and the memory information thereof. The scores are converged into the 1st to 10th percentiles, and then a user proportion of each quantile is calculated. Further, for example, a user device with a score of 5 or less may be defined as a low-end device, a user device with a score of 5 or more and 8 or less may be defined as a middle-end device, a user device with a score of 8 or more may be defined as a high-end device, and all the rated user devices may be defined as the whole pool.

In step S203, the performance baseline data is determined based on the first screen paint information of each user device loading the website and the model rating of each user device. In an embodiment of the present application, for a middle-end device, the first screen paint information corresponding to each middle-end device may be extracted from the first screen paint information of each user device loading the website. Then, multiple pieces of the extracted first screen paint information may be ranked in an ascending order, and divided into four equal parts. Then, a first quartile, a second quartile and a third quartile are extracted. For example, the first quartile is 500 ms, the second quartile is 1000 ms, and the third quartile is 1200 ms. Therefore, when the website launching speed is represented by a TP index, TP50<500 ms may indicate instant website launching, TP50<1000 ms may indicate sub-second website launching, and TP50<1200 ms may indicate near sub-second website launching, and TP50<500 ms, TP50<1000 ms and TP50<1200 ms constitute the performance baseline data corresponding to middle-end devices.

It will be appreciated that the above description of the performance baseline data corresponding to the middle-end device is merely exemplary, and in practical applications, the performance baseline data corresponding to each rated user device needs to be determined according to the practical application conditions, which is not limited in any way in the present application.

In step S204, performance optimization is performed for each website core scenario related to performance data.

When the website core scenario is a first screen launching scenario, performance optimization of the first screen launching scenario may specifically include the following operations: first, a launching task, a first screen link task and thread convergence are optimized, where during optimization of the launching task, all launching tasks may be incorporated into a launcher for management. The launcher may read launching task configuration, and construct a directed acyclic graph based on mutual dependencies between tasks, and the tasks are scheduled to different threads according to whether they are executed synchronously or not. Further, a core launching task is put into a core launcher for earlier execution according to a service attribute, and a non-core launching task is put into a non-core launcher for background execution. In addition, during optimization of the first screen link task, a task scheduler may be built to delay tasks not required by the first screen to be scheduled in a first screen idle stage based on task priorities. In addition, during optimization of the thread convergence, a suitable thread pool may be customized, and bytecode created by a thread can be read in the process of bytecode scanning through bytecode instrumentation, so that the bytecode for an unreasonable thread can be modified into an asynchronous thread created from the customized thread pool, thereby reducing the consumption of system resources. Then, first screen resources may be preloaded, and the resources required by the first screen may be persisted, which include first screen data, first screen pictures, first screen widgets, first screen class caches, and the like. Launching the first screen means loading to present the content in an accelerated manner. Next, a corresponding data parsing tool may be configured based on a data volume size. Specifically, for example, in the case of a fixed data model and a small data volume, a parsing tool of higher usability, such as Parcelable, may be configured, which can optimize the performance by implementing serialization and deserialization of objects. For a GSON framework on which massive data parsing depends, a GSONTypeFactoryAdapter corresponding to a model may be generated through compiled code generation and registered to the GSON framework, so that the reflection loss during data parsing is reduced. In general, the performance optimization of the first screen launching scenario can reduce unnecessary resource consumption, significantly accelerate the first screen launching speed of the website, and favorably improve the impression and retention rate of users during first use.

When the website core scenario is a long list scenario (which refers to a scenario where an application includes a list page of a large number of data items, such as a merchandise list or a message list), performance optimization of the long list scenario may specifically include the following operations: first, data splitting and optimization are performed based on a first screen display content and service data query time, where based on the display content of the first screen, non-first-screen redundant data may be split for later query to reduce the time consumed by first-screen data query and parsing. Meanwhile, based on the time consumed by queries of data of different service attributes, data with higher query efficiency may be returned first to participate in rendering, so that the rendering load is shared uniformly. Then, layout resources may be preloaded, where commonly used layout resources may be picked out according to a page view volume (PV) funnel of a widget and pre-requested, and pooling management is performed according to a production and consumption supply and demand relation of the resources. Resources which are used up are supplemented and stored in a cache pool in time. Next, layout rendering is optimized, where a tangent plane for a measurement logic of a key layout container in a layout level may be created through bytecode to output measurement information at a tangent point. It is detected whether there is a repeated measurement problem, and further optimization is performed if the problem is present. In general, the performance optimization of the long list scenario can solve the problem of frequent measurement, implement layout optimization of a cache-free scenario, improve the response speed and rendering efficiency of pages, and solve the problem of operation delay caused by a bloated layout.

When the website core scenario is a home tab scenario, performance optimization of the home tab scenario may specifically include: preloading tab resources. The resources for a tab may include, but are not limited to, tab data, tab pictures, tab widgets, and tab class caches which may be gradually loaded during idle periods after display of the first screen. In general, the performance optimization of the home tab scenario can achieve rapid page loading and smooth interface interaction.

When the website core scenario is a network dependent scenario, performance optimization of the network dependent scenario may specifically include: giving priority to processing of a status request operation and callback feedback of a request result subscription message. Giving priority to processing of the status request operation may specifically include: expanding an existing network framework so that the expanded framework supports feedback of status, such as a request callback, a request result, request abnormal information and the like, after a management request is sent. The request is immediately sent after a user click instead of after page initialization, and upon page initialization, a subscriber of the request result is directly bound to a pre-request so that the data return time is reduced. In addition, giving priority to processing of the callback feedback of the request result subscription message may specifically include: expanding a network framework so that the expanded framework supports placing the request result subscription message at the forefront of a main thread message loop, thereby reducing the data preparation time. In general, the performance optimization of the network dependent scenario can effectively reduce the waiting time of a user, and enhance smoothness of page interaction.

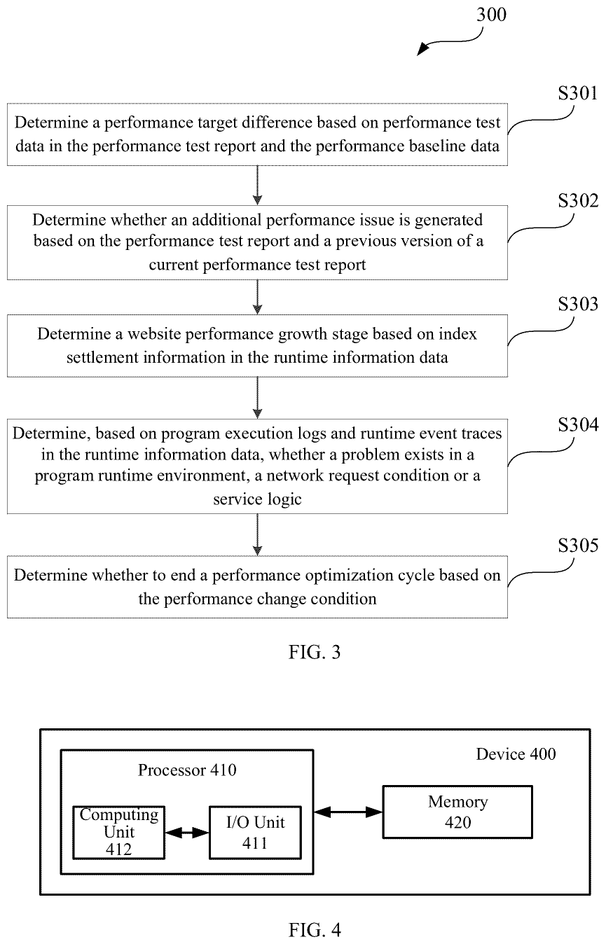

In some embodiments, the performance change condition may be monitored to prevent website performance degradation. The process of preventing website performance degradation will be described in detail below with reference to FIG. 3. FIG. 3 shows an exemplary flowchart of a website performance optimization method according to yet other embodiments of the present application. Referring to FIG. 3, a website performance optimization method according to an embodiment of the present application may include the following steps S301 to S305.

In step S301, a performance target difference is determined based on performance test data in the performance test report and the performance baseline data. In an embodiment of the present application, performance test data in the performance test report may be compared with the performance baseline data to obtain a difference, i.e., the performance target difference, between the performance test data and the performance baseline data.

In step S302, it is determined whether an additional performance issue is generated based on the performance test report and a previous version of a current performance test report. In an embodiment of the present application, the website performance data and the screen recording sensory data in the current performance test report and the previous version of performance test report may be compared one by one to determine whether data degradation occurs, and thereby determine whether an additional performance issue occurs.

In step S303, a website performance growth stage is determined based on index settlement information in the runtime information data. In an embodiment of the present application, the index settlement information may include, but is not limited to, time consumption data of each stage (for example, a route skipping stage, a page initialization stage, a network request stage, a data processing stage, a picture loading stage, and the like) in the first screen link. In an embodiment of the present application, a stage of performance growth and optimization can be determined by analyzing the time consumption data of each stage.

In step S304, based on program execution logs and runtime event traces in the runtime information data, it is determined whether a problem exists in a program runtime environment, a network request condition or a service logic. In an embodiment of the present application, whether the main thread message loop determines that the program runtime environment has a problem is determined by analyzing a memory watermark, garbage collection (GC) information, and current running processes and threads collected in the logs during the growth stage. In addition, whether picture loading and network requests are influenced may be determined by analyzing the time consumed by each stage of picture and network loading. In addition, whether the service logic is influenced may be determined by analyzing the time consumed by executing a method in the traces.

In step S305, it is determined whether to end a performance optimization cycle based on the performance change condition. It will be appreciated that if any performance deterioration condition is found in the analysis processes of the above steps S301 to S304, the performance change condition is determined as performance deterioration. If the performance change condition is performance deterioration, the step of performing performance optimization for each website core scenario related to performance data, and outputting a performance test report and runtime information data is repeated. Otherwise, the performance change condition is determined as performance optimization, and if the performance change condition is performance optimization, it is determined to end the performance optimization cycle.

Corresponding to the embodiments of the application function implementation method described above, the present application further provides a website performance optimization device and corresponding embodiments thereof.

FIG. 4 shows a block diagram of a hardware configuration of a website performance optimization device 400 that can implement the website performance optimization method according to an embodiment of the present application. As shown in FIG. 4, the website performance optimization device 400 may include a processor 410 and a memory 420. In the website performance optimization device 400 of FIG. 4, only constituent elements related to the present embodiment are shown. Therefore, it will be apparent to those of ordinary skill in the art that: the website performance optimization device 400 may further include common constituent elements other than those shown in FIG. 4, such as a fixed-point arithmetic unit.

The website performance optimization device 400 may correspond to a computing device having various processing functions, such as functions for generation, training or learning of a neural network, for quantizing a floating point type neural network to a fixed point type neural network, or for retraining a neural network. For example, the website performance optimization device 400 may be implemented as various types of devices, such as a personal computer (PC), a server device, a mobile device, and so on.

The processor 410 controls all functions of the website performance optimization device 400. For example, the processor 410 controls all functions of the website performance optimization device 400 by executing programs stored on the memory 420 in the website performance optimization device 400. The processor 410 may be implemented by a central processing unit (CPU), a graphics processing unit (GPU), an application processor (AP), an intelligent processing unit (IPU), and the like provided in the website performance optimization device 400. However, the present application is not limited thereto.

In some embodiments, the processor 410 may include an input/output (I/O) unit 411 and a computing unit 412. The I/O unit 411 may be configured to receive various types of data, such as performance baseline data. Illustratively, the computing unit 412 may be configured to perform performance optimization for each website core scenario related to performance data, and output a performance test report and runtime information data; determine a performance change condition of the website based on the performance baseline data, the performance test report and the runtime information data; and determine whether to end a performance optimization cycle based on the performance change condition. The result of whether to end the performance optimization cycle may be output from the I/O unit 411, for example. The output data may be provided to the memory 420 for reading by other devices (not shown), or may be provided directly to other devices for use.

The memory 420 is hardware for storing various types of data processed in the website performance optimization device 400. For example, the memory 420 may store processed data and data to be processed in the website performance optimization device 400. The memory 420 may store datasets, such as performance baseline data or the like, processed or to be processed by the processor 410 involved in steps of the website performance optimization method. Further, the memory 420 may store applications to be driven by the website performance optimization device 400, drivers, and the like. For example: the memory 420 may store various programs related to a website performance optimization method to be executed by the processor 410. The memory 420 may be a DRAM, but the present application is not limited thereto. The memory 420 may include at least one of a volatile memory or a non-volatile memory. The non-volatile memory may include a read-only memory (ROM), a programmable ROM (PROM), an electrically programmable ROM (EPROM), an electrically erasable programmable ROM (EEPROM), a flash, phase-change RAM (PRAM), a magnetic RAM (MRAM), a resistive RAM (RRAM), a ferroelectric RAM (FRAM), or the like. The volatile memory may include a dynamic RAM (DRAM), a static RAM (SRAM), a synchronous DRAM (SDRAM), a PRAM, an MRAM, an RRAM, a ferroelectric RAM (FeRAM), or the like. In an embodiment, the memory 420 may include at least one of a hard disk drive (HDD), a solid state drive (SSD), a compact flash (CF), a secure digital (SD) card, a Micro-SD card, a Mini-SD card, an xD card, a cache, or a memory stick.

In summary, specific functions implemented by the memory 420 and the processor 410 of the website performance optimization device 400 provided in the implementations of the present disclosure may be explained in comparison with the foregoing implementations in the description of the present disclosure, and can achieve the technical effects of the foregoing implementations, and therefore, no further description is provided here.

In this implementation, the processor 410 may be implemented in any suitable manner. For example, the processor 410 may take the form of, for example, a microprocessor or processor and a computer-readable medium that stores a computer-readable program code (e.g., software or firmware) executable by the (micro) processor, a logic gate, a switch, an application specific integrated circuit (ASIC), a programmable logic controller, an embedded microcontroller, or the like.

It will also be appreciated that any module, unit, component, server, computer, terminal or device exemplified herein that executes instructions may include or otherwise have access to computer-readable media such as storage media, computer storage media, or data storage devices (removable and/or non-removable) such as, for example, magnetic disks, optical disks or tape. The computer storage medium may include volatile and non-volatile, removable and non-removable media implemented in any method or technology for storage of information, such as computer-readable instructions, data structures, program modules, or the like.

The foregoing may be better understood in light of the following clauses:

Clause A1. A website performance optimization method, including: creating performance baseline data; performing performance optimization for each website core scenario related to performance data, and outputting a performance test report and runtime information data; determining a performance change condition of the website based on the performance baseline data, the performance test report and the runtime information data; and determining whether to end a performance optimization cycle based on the performance change condition.

Clause A2. The website performance optimization method of clause A1, wherein creating the performance baseline data includes: acquiring a processor frequency and memory information of each user device and first screen paint information of each user device loading the website; determining a model rating of each user device based on its processor frequency and the memory information, and determining the performance baseline data based on the first screen paint information of each user device loading the website and the model rating of each user device.

Clause A3. The website performance optimization method of clause A1, wherein the website core scenario is a first screen launching scenario, wherein performance optimization of the first screen launching scenario includes: optimizing a launching task, a first screen link task and thread convergence; preloading first screen resources; and configuring a corresponding data parsing tool based on a data volume size.

Clause A4. The website performance optimization method of clause A1, wherein the website core scenario is a long list scenario, wherein performance optimization of the long list scenario includes: performing data splitting and optimization based on a first screen display content and service data query time; preloading layout resources; and optimizing layout rendering.

Clause A5. The website performance optimization method of clause A1, wherein the website core scenario is a home tab scenario, wherein performance optimization of the home tab scenario includes: preloading tab resources.

Clause A6. The website performance optimization method of clause A1, wherein the website core scenario is a network dependent scenario, wherein performance optimization of the network dependent scenario includes: giving priority to processing of a status request operation and callback feedback of a request result subscription message.

Clause A7. The website performance optimization method of clause A1, wherein determining the performance change condition of the website based on the performance baseline data, the performance test report and the runtime information data includes: determining a performance target difference based on performance test data in the performance test report and the performance baseline data; determining whether an additional performance issue is generated based on the performance test report and a previous version of a current performance test report; determining a website performance growth stage based on index settlement information in the runtime information data; and determining, based on program execution logs and runtime event traces in the runtime information data, whether a problem exists in a program runtime environment, a network request condition or a service logic.

Clause A8. The website performance optimization method of clause A1, wherein determining whether to end the performance optimization cycle based on the performance change condition includes: if the performance change condition is performance optimization, determining to end the performance optimization cycle; and if the performance change condition is performance deterioration, repeating the step of performing performance optimization for each website core scenario related to performance data, and outputting a performance test report and runtime information data.

Clause A9. A website performance optimization device, including: a memory; and at least one processor configured to: create performance baseline data; perform performance optimization for each website core scenario related to performance data, and output a performance test report and runtime information data; determine a performance change condition of the website based on the performance baseline data, the performance test report and the runtime information data; and determine whether to end a performance optimization cycle based on the performance change condition.

Clause A10. A non-transitory machine-readable medium having a program code for website performance optimization stored thereon which, when executed by at least one processor, directs the at least one processor to perform the operations of: creating performance baseline data; performing performance optimization for each website core scenario related to performance data, and outputting a performance test report and runtime information data; determining a performance change condition of the website based on the performance baseline data, the performance test report and the runtime information data; and determining whether to end a performance optimization cycle based on the performance change condition.

What is claimed is:

1. A website performance optimization method, comprising:
creating performance baseline data;
performing performance optimization for each website core scenario related to performance data, and outputting a performance test report and runtime information data;
determining a performance change condition of the website based on the performance baseline data, the performance test report and the runtime information data; and
determining whether to end a performance optimization cycle based on the performance change condition.

2. The website performance optimization method of claim 1, wherein creating the performance baseline data includes:
acquiring a processor frequency and memory information of each user device and first screen paint information of each user device loading the website;
determining a model rating of each user device based on its processor frequency and the memory information; and
determining the performance baseline data based on the first screen paint information of each user device loading the website and the model rating of each user device.

3. The website performance optimization method of claim 1, wherein the website core scenario is a first screen launching scenario, and performance optimization of the first screen launching scenario includes:
optimizing a launching task, a first screen link task and thread convergence;
preloading first screen resources; and
configuring a corresponding data parsing tool based on a data volume size.

4. The website performance optimization method of claim 1, wherein the website core scenario is a long list scenario, and performance optimization of the long list scenario includes:
performing data splitting and optimization based on a first screen display content and service data query time;
preloading layout resources; and
optimizing layout rendering.

5. The website performance optimization method of claim 1, wherein the website core scenario is a home tab scenario, and performance optimization of the home tab scenario includes:
preloading tab resources.

6. The website performance optimization method of claim 1, wherein the website core scenario is a network dependent scenario, and performance optimization of the network dependent scenario includes:
giving priority to processing of a status request operation and callback feedback of a request result subscription message.

7. The website performance optimization method of claim 1, wherein determining the performance change condition of the website based on the performance baseline data, the performance test report and the runtime information data includes:
determining a performance target difference based on performance test data in the performance test report and the performance baseline data;
determining whether an additional performance issue is generated based on the performance test report and a previous version of a current performance test report;
determining a website performance growth stage based on index settlement information in the runtime information data; and
determining, based on program execution logs and runtime event traces in the runtime information data, whether a problem exists in a program runtime environment, a network request condition or a service logic.

8. The website performance optimization method of claim 1, wherein determining whether to end the performance optimization cycle based on the performance change condition includes:
if the performance change condition is performance optimization, determining to end the performance optimization cycle; and
if the performance change condition is performance deterioration, repeating the step of performing performance optimization for each website core scenario related to performance data, and outputting a performance test report and runtime information data.

9. A website performance optimization device, comprising:
a memory; and
at least one processor configured to:
create performance baseline data;
perform performance optimization for each website core scenario related to performance data, and output a performance test report and runtime information data;
determine a performance change condition of the website based on the performance baseline data, the performance test report and the runtime information data; and
determine whether to end a performance optimization cycle based on the performance change condition.

10. The website performance optimization device of claim 9, wherein the processor is further configured to create the performance baseline data by:
acquiring a processor frequency and memory information of each user device and first screen paint information of each user device loading the website;
determining a model rating of each user device based on its processor frequency and the memory information; and
determining the performance baseline data based on the first screen paint information of each user device loading the website and the model rating of each user device.

11. The website performance optimization device of claim 9, wherein the website core scenario is a first screen launching scenario, and the processor is further configured to perform performance optimization of the first screen launching scenario by:
optimizing a launching task, a first screen link task and thread convergence;
preloading first screen resources; and
configuring a corresponding data parsing tool based on a data volume size.

12. The website performance optimization device of claim 9, wherein the website core scenario is a long list scenario, and the processor is further configured to perform performance optimization of the long list scenario by:
performing data splitting and optimization based on a first screen display content and service data query time;
preloading layout resources; and
optimizing layout rendering.

13. The website performance optimization device of claim 9, wherein the website core scenario is a home tab scenario, and the processor is further configured to perform performance optimization of the home tab scenario by:
preloading tab resources.

14. The website performance optimization device of claim 9, wherein the website core scenario is a network dependent scenario, and the processor is further configured to perform performance optimization of the network dependent scenario by:
giving priority to processing of a status request operation and callback feedback of a request result subscription message.

15. The website performance optimization device of claim 9, wherein the processor is further configured to determine the performance change condition of the website based on the performance baseline data, the performance test report and the runtime information data by:
determining a performance target difference based on performance test data in the performance test report and the performance baseline data;
determining whether an additional performance issue is generated based on the performance test report and a previous version of a current performance test report;
determining a website performance growth stage based on index settlement information in the runtime information data; and
determining, based on program execution logs and runtime event traces in the runtime information data, whether a problem exists in a program runtime environment, a network request condition or a service logic.

16. The website performance optimization device of claim 9, wherein the processor is further configured to determine whether to end the performance optimization cycle based on the performance change condition by:
if the performance change condition is performance optimization, determining to end the performance optimization cycle; and
if the performance change condition is performance deterioration, repeating the step of performing performance optimization for each website core scenario related to performance data, and outputting a performance test report and runtime information data.

17. A non-transitory machine-readable medium having a program code for website performance optimization stored thereon which, when executed by at least one processor, directs the at least one processor to perform the operations of:
creating performance baseline data;
performing performance optimization for each website core scenario related to performance data, and outputting a performance test report and runtime information data;
determining a performance change condition of the website based on the performance baseline data, the performance test report and the runtime information data; and
determining whether to end a performance optimization cycle based on the performance change condition.
